(19) United States
(12) Patent Application Publication
(10) Pub. No.: US 2021/0321236 A1
(43) Pub. Date: Oct. 14, 2021

(54) SYSTEM AND METHOD FOR DOWNLOADING CONTENT AND PLAYING THE CONTENT AT A VEHICLE

(71) Applicants: DENSO International America, Inc., Southfield, MI (US); Denso Corporation, Kariya (JP)

(72) Inventor: Jeffrey TURK, South Lyon, MI (US)

(21) Appl. No.: 16/844,553

(22) Filed: Apr. 9, 2020

(51) Int. Cl. H04W 4/70; H04W 4/80

(52) U.S. Cl. CPC H04W 4/70; H04W 84/18; H04W 4/80

(57) ABSTRACT

A vehicle computer system includes a wireless transceiver configured to allow a vehicle to communicate with a remote server and a processor in communication with the remote server. The processor is configured to receive one or more settings indicating a preference for downloading content at the remote server to the vehicle, send instructions to the remote server to download the content in response to the preference, download the content from the remote server, output the content at the vehicle.

### TECHNICAL FIELD

The present disclosure relates to digital video content, or other media, that is played at a vehicle.

### BACKGROUND

Vehicles may be equipped with rear seat entertainment (RSE) systems or other displays in the vehicle to display media content from a variety of sources. The RSE systems may have the capability to stream video content from the Internet utilizing streaming services, like YouTube, Netflix, Hulu, etc. However, these streaming services may utilize bandwidth of a vehicle's Internet connection. The bandwidth usage may affect other vehicle operation that may require bandwidth to download data from off-board servers and services, especially in an autonomous vehicle setting that requires communication to remote servers. It would be beneficial to allow the capability of playing such content in the vehicle during vehicle operation, but not utilize vehicle bandwidth.

### SUMMARY

According to one embodiment, a vehicle computer system includes a wireless transceiver configured to allow a vehicle to communicate with a remote server and a processor in communication with the remote server. The processor is configured to receive one or more settings indicating a preference for downloading content at the remote server to the vehicle, send instructions to the remote server to download the content in response to the preference, download the content from the remote server, output the content at the vehicle.

According to a second embodiment, a vehicle computer system includes a processor configured to receive one or more settings indicating a preference for downloading content from a remote server to a vehicle, send instructions to the remote server to download the content in response to the preference, wherein the preference indicates a vehicle setting to download the content without human intervention to initiate the download, download the content from the remote server to the vehicle; and output the content at a display in the vehicle.

According to a third embodiment, a method of downloading content at a vehicle includes receiving one or more settings indicating a preference for downloading content at the remote server to the vehicle, sending instructions to the remote server to download the content in response to the preference, downloading the content from the remote server when the vehicle is at a vehicle ignition on cycle, and outputting the content at the vehicle in response to a vehicle ignition on cycle.

### BRIEF DESCRIPTION OF THE DRAWINGS

FIG. 1 shows a block diagram of a vehicle computer system.

FIG. 2 is an example flow chart of a system that can predict user content and utilize off-peak hours to preload such content.

FIG. 3 is an example user interface screen 300 of the system to modify preferences.

FIG. 4 is an example user interface screen 400 of a preference screen.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

During long trips, a rear seat entertainment system (RSE) may be utilized heavily by passengers. Current RSE systems may include media players with Internet capabilities to download or stream content. However, such content may require heavy bandwidth due to their data size and utilize most or all of the bandwidth in the vehicle. This could lead to the slow down of other vehicle applications that require utilization of the Internet or connections to remote servers utilizing wireless transmission. Thus, rather than streaming the video content in real time, it may be beneficial to preload the content. However, users may not forget to preload the content. The embodiments described below include various examples of a system that may utilize various preferences that are determined by the vehicle computer system or set by the user, to preload content. The content may be preloaded in anticipation for heavy use of the RSE or for other reasons, such as an upcoming trip or a favorite show being broadcasted during a commuting time of the vehicle.

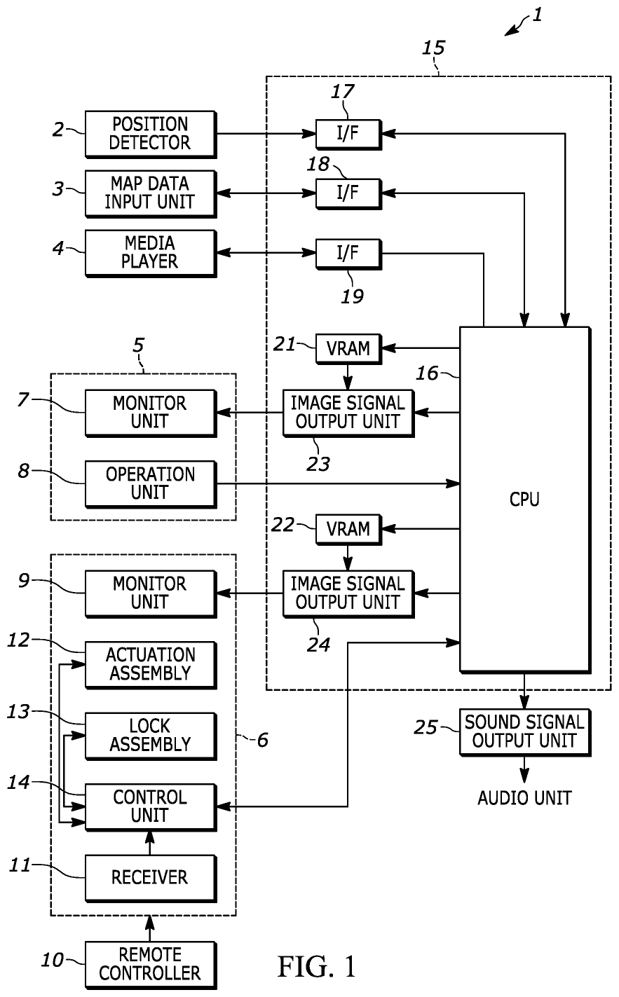

FIG. 1 shows a block diagram of the navigation system 1 that may have abilities to communicate with a rear seat entertainment system (RSE) or another display or system in the vehicle. The navigation system 1 includes a position detector 2 with a GPS receiver for determining a current position of a vehicle based on a GPS signal installed therein. The position detector 2 may be a global position system (GSP) or any other type of system for identifying a location. The navigation system 1 may also include a map data input unit 3 for retrieving map data and facility data (e.g., point of interest (POI) data) from information medium such as a hard disk or the like. The map data input unit 3 may retrieve the map data from a remote server as well. The navigation system 1 may also include a media player 4 for retrieving image data and sound data from various media sources. The media player 4 may also be capable of communicating to the Internet via a wireless transceiver to download streaming content, such as Netflix, Youtube, etc. The wireless transceiver may be built into the navigation system (e.g., onboard modem) or utilize a mobile device in wireless communication (e.g., Bluetooth connection) with the vehicle computer system to connect to remote servers. The navigation system 1 may include a front monitor 5 to be viewed by occupants in front seats of the vehicle, and a back monitor 6 to be viewed by occupants in seats of the vehicle. The front monitor 5 and the back monitor 6 are used to display travel information such as a road map, a navigation route, a facility, and/or an image of an entertainment program recorded on the Blu-ray, or other similar media via the media player 4. Given that the navigation system has wireless capabilities to connect to the internet, the front monitor 5 and the back monitor 6 may be able to stream a variety of content.

The front monitor 5 may installed in an instrument panel or any other area in the view of the front passengers and/or driver. The front monitor 5 may be used to display the travel information and/or images for a driver of the vehicle. The front monitor 5 may also be utilized to stream any type of media in communication with the media player. The back monitor 6 may installed on a ceiling of the vehicle and is used to display the images for the occupants of the back seats as a rear seat entertainment system (RSE). The back monitor 6 may also be installed in headrests of the vehicle or may be tablets that are mounted on headrests. The front monitor 5 includes a monitor unit 7 that uses a liquid crystal display unit and an operation unit 8 for input operations. The back monitor 6 includes a monitor unit 9 that uses the liquid crystal display unit, a receiver 11 for receiving a signal from a remote controller 10, an actuation assembly 12 for opening and closing the monitor unit 9, a lock assembly 13 for locking the monitor unit 9, and a control unit 14 that controls operation of the actuation assembly 12 and the lock assembly 13.

The position detector 2, the map data input unit 3, the media player 4, the front monitor 5, and the back monitor 6 may be coupled with a control unit 15 of the navigation system 1 that controls display operation on those components. The control unit 15 may be a processor or controller. In alternative embodiments, the control unit 14 and control unit 15 may be encompassed by a single processor or controller to control the individual functionalities in a single unit. The control unit 15 may include a CPU 16 that provides computing function, and receives signals from the position detector 2, the map data input unit 3, and the media player 4 through an interface (I/F) 17, 18, 19. The interfaces 17, 18, 19 may be USB, HDMI, CAN, or any other type of interface that could be utilized in the vehicle. The navigation system 1 may be in communication with other vehicle sensors or devices in the vehicle. The devices may include a mobile phone or other mobile device that may be brought in by an occupant.

The control unit 15 also includes video RAMs (VRAMs) 21, 22 for storing image data, and image output units 23, 24 for outputting the image signal after converting the image data in the VRAMs 21, 22. The monitor units 7, 9 in the front/back monitor 5, 6 display image based on the image signal from the image output units 23, 24. The VRAM may be any time of memory or hard disk drive that can store such video content or other media content. The content may be high-definition video or any type of digital video, image, music, or other content, etc.

The control unit 15 (e.g., processor) may further include a sound signal output unit 25 that controls conversion of sound data. The sound data may include the sound accompanying various media, such as the sound played in a video file or the sound played in an audio file. The control until may also be capable of outputting sound related to the travel information and output of guidance voice based on the travel information from an audio system including an amplifier/a speaker or the like.

The control unit 15 in the navigation system 1 receives various instruction inputs from users that controls the operation unit 8 in the front seats and/or the remote controller 10 in the back seats. The control unit 15 may be also referred to as a processor or controller. The CPU 16 in the control unit 15 may be configured to execute a calculation operation, display travel information, road map, guidance image and/or control menus for setting a destination or for setting system configuration or the like on the monitor units 7, 9 based on the inputted instructions. Further, the CPU 16 controls output of control signals from the sound signal output unit 25 for the guidance voice that guides the travel information, setting operations or the like.

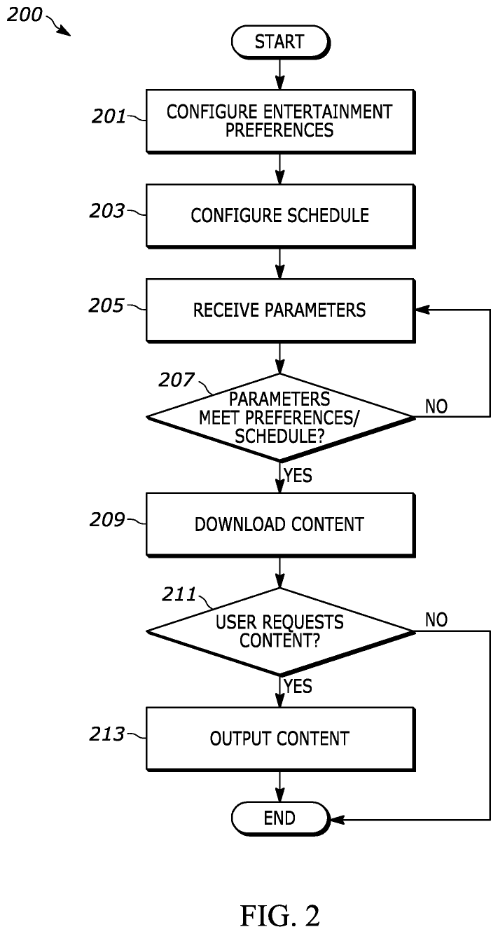

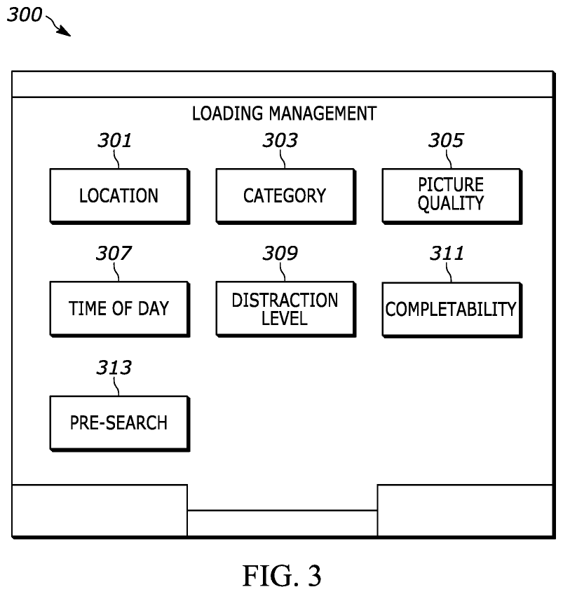

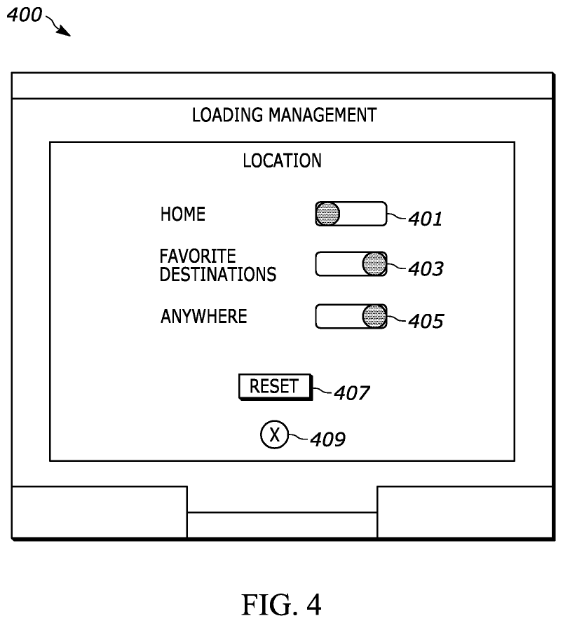

FIG. 2 is an example flow chart of a system that can predict user content and utilize off-peak hours to preload such content. The content may include videos, music, or other media. It may be most beneficial for the system to download content that is larger size content, such as high-definition or high-quality videos (e.g., 4K video, 8K video, etc.). Thus, the content may be multiple gigabytes in one example. At step 201, the system may configure the entertainment preferences or streaming preferences. The system may have a user manually edit the preferences for downloading content or streaming content in one example. Such examples of settings are shown and explained with respect to FIGS. 3 and 4 below. The preferences may include options to edit the type of videos, audio, or other media content to download. The preferences may also include options to focus on “off-peak” hours to download that content.

At step 203, the system may utilize the options or data collected from the vehicle to configure the schedule for downloading content. The schedule for downloading content may attempt to download the content when not driving (e.g., the vehicle is parked) to conserve bandwith. The schedule may be necessary to allow the vehicle to wirelessly download streaming content in off-peak hours. The system may search for content based on preferences (e.g., content preferences) utilizing historical data, such as information for the most watched shows in the vehicle. The system may determine the most watched shows for a specific monitor or display in the car in the vehicle as well. For example, the vehicle system may determine that a front monitor may prefer to watch sports while a monitor in an RSE system may prefer to watch cartoons or other kids programs. The system may also determine preferences for downloading content utilizing user settings or historical data that may aid in determining when to download the content. For example, a setting may determine a preference which instructs the vehicle a time to possibly download content while the vehicle is not activated.

At step 205, the system may receive the parameters or other information from various vehicle sensors to determine if the system should begin to download content or to not download content. The vehicle may attempt to download the content during “off-peak” hours when the vehicle is not being utilized. The vehicle may be in communication with other vehicle sensors or devices to receive such data. For example, the GPS receiver may utilize location data to identify a location that may be beneficial to download content at since the vehicle may be parked there for significant amount of time, such as a home or office location. The content to download may be selected automatically (without human intervention) or manually. For example, the system may automatically download content which it believes the participants would like to view or prefer. In another situation, the system may select to download the content based on a watch list indicating content (e.g., videos, series, movies, shows, audio, etc.) that the user prefers to watch. When the content is viewed, it may be removed from the watchlist.

At decision 207, the system may determine if the parameters are met. The system may compare the data that is collected with the settings initiated by the user, or that are automatically determined by default via the system. When the system automatically determines that preferences are met, the system may rely on historical data that is collected by various vehicle sensors or devices that are in communication with the vehicle over a certain time period. The historical data may indicate behavior and preferences of the user without needing the user to provide specific input regarding the preference. For example, if the vehicle determines that a user typically drives from home to work between the hours of 8 AM to 9 AM (utilizing the location data from a GPS receiver as well as the time of day of travel from a clock or the GPS receiver), it may determine that the vehicle should not attempt to download content from the remote sources (e.g., server) at those times. Once the content is selected that should be downloaded or to view, the system may determine if the vehicle is in the proper environment, setting, or situation to download the content. Thus, the vehicle will not attempt to download the content and utilize bandwidth during peak hours or peak driving times. The vehicle may look at location data, distraction level of the content, time of day, picture quality or audio quality of the content, schedule/calendar or upcoming schedule, and other types of data collected at the vehicle to determine if it is appropriate to download the content. The content may be downloaded in one download or split over multiple downloads (e.g., multiple sessions) to ensure that the content is not downloaded at peak times.

At step 209, the system may download the content. Instructions may be sent from the processor to the remote server or broadcaster to initiate downloading of the data. The data may be downloaded in one continuous stream or may be split to accommodate the goal of downloading the content at the vehicle during off-peak hours. For example, a download may stop if the settings indicate that the vehicle is not at off-peak hours. The system may also download the content during driving scenarios. For example, the system may download the content during a traffic jam (e.g., receive traffic data from the navigation system or remote server), red light (e.g., receive data from an image recognition system or vehicle camera), stopped car (e.g., receive data from a vehicle speed sensor), slow moving car (e.g., receive data from the vehicle speed sensor), etc. However, the system may weigh confidence at a higher level to download during off peak hours if the vehicle is off (e.g., engine off or battery off). The vehicle may ensure that the vehicle has a wireless connection to the content-source (e.g. the cloud). The vehicle may also include an option to only download while on a specific connection, such as a Wi-Fi connection, to ensure that no bandwidth is ever utilized on the vehicle's cellular connection (e.g., 4G, 5G, LTE connection). As discussed, the downloading may occur in multiple steps.

At decision 211, the system may determine if a user or passenger requested the content. This may occur during a vehicle ignition on cycle (e.g., engine turned on, battery turned on, vehicle turned on, etc.). The user may activate an application or mode of an RSE, or other vehicle computer system, to begin watching the content. The media source may include options to view the streaming content that has now been downloaded. In another scenario, the vehicle computer system may provide a recommendation of favorite content to view. In yet another option, if the occupant attempts to watch content that is streamed, the vehicle system may provide an option to view suggested downloaded content. The vehicle computer system may download and store the content locally at the vehicle (e.g., hard drive or other memory).

At step 213, the system may output the content. The content may be output at the vehicle via the vehicle computer system that has one or more monitors or displays. Thus, any display in the vehicle may output the streaming content, including the navigation screen, the RSE displays, the instrument panel screen, etc. The system may output the downloaded content based on the vehicle environment settings. For example, the vehicle may decide to only view content during a vehicle stop setting. Rather than streaming the content, the content will be played based on it being available locally. Thus the content will be stored on local memory or a hard drive in the vehicle. It also should be noted that given that the content is not necessarily downloaded in one session, the vehicle may output or play the content even if the download is not finished. Thus, the playing of the downloaded content may not contain the full content (e.g., may contain only half a movie). If the user is watching the content that was not fully downloaded, it may output a message to the user indicating a wireless connection may be required to stream the content. The user may have the option of either downloading the content (e.g., download at peak times or off-peak times), or watch the content during streaming. Thus, even watch partly downloaded content may save bandwidth in the vehicle.

FIG. 3 is an example user interface screen 300 of the system. The user interface screen 300 may include a variety of options for how the system may pre-load content. The options may be utilized to establish different weights for the vehicle system to determine when to preload/download the content. The interface screen 300 may be an interface for a user to manage or tailor how the content is preloaded. The system may have a first option to offer content loading based on location 301. The location 301 may be set by a user for frequently traveled areas that have a long rest area, such as a home or place of work. For example, the car may be parked much longer at home or a gym to allow off-board (e.g., not while driving) as opposed to a restaurant or other type of area. Further detail regarding the location option 301 is explained with respect to FIG. 4 below.

The interface screen 300 may have another setting based on category 303 associated with the content. The category 303 option may allow for the video or entertainment category of the content to be loaded. This may be due to the loading requirements for certain categories. For example, a short Youtube skit may utilize less capacity than a full-length HD movie. In yet another example, an audio album may be even less than a Youtube skit. Thus, the system may allow the category to be based on audio, length of the movie, or other options.

The interface screen 300 may also include a setting based on picture quality 305. The picture quality 305 option may allow for the content to be loaded based on the picture quality. For example, the picture quality of higher definition video may utilize more capacity than a standard definition video or audio. This may be due to the loading requirements for higher quality videos to require larger capacity for storage and streaming. For example, an 8K high definition video may utilize more capacity than standard definition movie of the same length. In yet another example, a 4K video may require even more capacity than an audio album. The settings may allow for adjustment based on 8K, 4K, audio quality, higher definition, standard definition, etc.

The interface screen 300 may also include a setting based on the time of day 307. The time of day 307 option may help the user identify slow times for the user when the vehicle is not driving. For example, a user may not typically utilize the vehicle from 8 PM until 7 AM. This preference may allow the vehicle to load the content based on the user's time preference. While the setting may allow a user to select times to download the content when the vehicle is off, the setting may also allow for ignoring the effect of the time of day with respect to downloading content at the vehicles. In another option, the setting may allow a user to select when the vehicle should not allow the content to be loaded (e.g., downloaded). Thus, the user may select times to avoid downloading the content.

The interface screen 300 may include yet another option for a distraction level setting 309. The distraction level setting 309 may be utilized to load specific content based on the amount of distraction the content has. The video content (or any other type of content) may include metadata that may score the distraction level or include attribute data to specify how a category of the content may be for distraction levels. For example, a sporting event may be a high distraction level and has data indicating as such. Yet in another example, a talk show may be a medium distraction level and has data indicating as such. In yet another example, audio only may have a very low distraction level. The distraction level may receive a score, or a weight based on the category. The options may also allow a driver to only view that content during low cognitive demand periods at the vehicle, such as when the vehicle is parked or at a red light.

The interface screen 300 may include yet another option for completability 311 of downloading the content at a window. The completability 311 option may be related to the size of the content attempting to be loaded as compared to the time period that the vehicle will attempt to download the content. The vehicle computer system may calculate the time it would take to download the content and compare the download time to the departure time of the vehicle. If the computer system determines that the download time may be a certain period of time (e.g., download period time), it may compare the download period time to the off-peak period time. The off-peak period time may indicate a time that the vehicle may not be utilized or be driven.

The interface screen 300 may include yet another option for pre-searching 313. The pre-search 313 option (or pre-searching option or “pre-hunting” option) may allow the vehicle computer system to hunt for prospective video content. The vehicle computer system may then find video content that is based on historical data that indicates what a passenger watched in the past. The pre-search option may allow the driver or passengers of the vehicle to receive suggestions of content to load when timing permits. The feature may be useful if the user does not provide any content to download in the watchlist. For example, if it knows a driver typically likes to watch sports highlights (e.g., basketball highlights), it may search for that content. The pre-searching option 313 may work in a scenario when no content is decided to be downloaded in the watchlist. In another embodiment, the pre-searching option 313 may be available regardless of whether the watchlist is populated or not.

While certain options are shown, other options or preferences may be included. For example, the system may include a preference or option that considers a user's schedule or a schedule of the vehicle. If the vehicle determines that an upcoming trip is scheduled, it may allow more flexibility in downloading content since the bandwidth usage may be heavy during a long trip. The vehicle may be in communication with a remote server that provides access to upcoming trip information, like nearby hotel or lodging information. In yet another example, the vehicle may have access to a driver's schedule and determine from data that a meeting is occurring. The vehicle may determine that the meeting is occurring in peak usage hours of the vehicle. The vehicle may then determine to adjust a schedule for downloading the content based on the schedule indicating a likelihood that the meeting will prevent the vehicle from being used.

FIG. 4 may be an example of preference screen 400 that allows adjustment of an individual option. The user interface screen 400 shown is, for example, a setting screen for the loading management as utilized based on location. This may be referred to as location option 301 in FIG. 3. Each of the options that are shown in FIG. 3 may have a preference screen such as the one shown in preference screen 400. The location preference may include an option to prefer load management at home 401. The home option 401 may allow the vehicle to prepopulate the downloadable content when at home if the feature is activated. If the feature is not activated, it may not weight the home location anymore. The assumption may be that when the user's vehicle is at a defined home location, the vehicle may not be in use for a prolonged time and the system may download content when the vehicle is turned off at the home location. Another option may be a favorite destination 403. The system may be monitoring location data associated with specific coordinates or POIs. The system may identify favorite locations by identifying frequency visited locations or based on a manual input from the driver. One the feature is activated the vehicle may attempt to download content at those favorite locations upon the vehicle parking or the vehicle ignition being off (e.g., engine turning off or battery turning off or stopping operation of the vehicle). Another option may be that the vehicle attempts to download content at any location 405. The system may thus allow the vehicle to automatically begin downloading content when the vehicle ignition was off at any locations. If the “any location” 405 option is turned off, however, the system may only download the content at specified locations. The options related to the location may only download the content when the vehicle is off in one embodiment. However, in another embodiment, the vehicle may download the content at arriving at those specific locations regardless if the vehicle is off or not. The preference screen 400 may also include a reset option 407 to reset each setting to the default factory setting, or a cancel option 409 to return to a previous screen.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A vehicle computer system, comprising:
a wireless transceiver configured to allow a vehicle to communicate with a remote server;
a processor in communication with the remote server, the processor configured to:
receive one or more settings indicating a preference for downloading video content at the remote server to the vehicle, wherein the preference includes a location of the vehicle;
send instructions to the remote server to download the video content in response to the preference indicating the location of the vehicle;
download the video content from the remote server; and
output the video content at the vehicle.

2. The vehicle computer system of claim 1, wherein the processor is further programmed to output the content at the vehicle without receiving any data associated with the video content from the remote server.

3. The vehicle computer system of claim 1, wherein the video content includes high definition video.

4. The vehicle computer system of claim 1, wherein the processor is configured stop downloading the video content from the remote server in response to the preference not being met at the vehicle.

5. The vehicle computer system of claim 1, wherein the processor is configured stop outputting the video content from the remote server in response to the preference not being met at the vehicle.

6. The vehicle computer system of claim 1, wherein the preference includes a time of the day.

7. The vehicle computer system of claim 1, wherein the preference includes a category associated with the video content.

8. The vehicle computer system of claim 1, wherein the preference includes a time of day that the vehicle is parked.

9. The vehicle computer system of claim 1, wherein the processor is further programmed to output the video content in response to a vehicle ignition cycle on.

10. A vehicle computer system, comprising:
a processor configured to:
receive one or more settings indicating a preference for downloading video content from a remote server to a vehicle, wherein the preference includes a location of the vehicle;
send instructions to the remote server to download the video content in response to the preference, wherein the preference indicates a vehicle setting to download the content without human intervention to initiate the download;
download the content from the remote server to the vehicle; and
output the content at a display in the vehicle.

11. The vehicle computer system of claim 10, wherein the processor is further programmed to download the content when the vehicle is off.

12. The vehicle computer system of claim 10, wherein the processor is further programmed to output the content at the vehicle when not connected to the remote server.

13. The vehicle computer system of claim 10, wherein the processor is further programmed to download the content when the vehicle is in a traffic situation as indicated by traffic data.

14. The vehicle computer system of claim 10, wherein the processor is further programmed to download the content when the vehicle is stopped at a red light as indicated by image data received from a vehicle camera.

15. The vehicle computer system of claim 10, wherein the processor is further programmed to download the content in response to historical data indicating preferences of content viewed on a display of the vehicle computer system.

16. A method of downloading content at a vehicle, comprising:
receiving one or more settings indicating a preference for downloading video content at the remote server to the vehicle, wherein the preference includes a location of the vehicle;
sending instructions to the remote server to download the video content in response to the preference;
downloading the video content from the remote server when the vehicle is at a vehicle ignition on cycle; and
outputting the video content at the vehicle in response to a vehicle ignition on cycle.

17. The method of claim 16, where in the preference is automatically set without human intervention utilizing historical data.

18. The method of claim 16, where in the preference is manually set with human intervention.

19. The method of claim 16, wherein outputting the video content at the vehicle does not utilize a connection to the remote server.

20. The method of claim 16, wherein the method includes selecting the video content in response to historical data indicating preferences of video content viewed at the vehicle computer system.
